(19) United States
(12) Patent Application Publication
(10) Pub. No.: US 2007/0091818 A1
(43) Pub. Date: Apr. 26, 2007

(54) Monitoring system

(75) Inventors: Kevin D. Kroupa, Ballwin, MO (US); James A. Wilson, Fairview Heights, IL (US); Christopher A. Scholz, Fenton, MO (US)

Correspondence Address: GREENSFELDER HEMKER & GALE PC, SUITE 2000, 10 SOUTH BROADWAY, ST LOUIS, MO, 63102, US

(73) Assignee: Allied Healthcare Products, Inc., St. Louis, MO (US)

(21) Appl. No.: 11/586,405

(22) Filed: Oct. 25, 2006

Related U.S. Application Data
(60) Provisional application No. 60/729,933, filed on Oct. 25, 2005.

(51) Int. Cl. H04J 1/16

(52) U.S. Cl. 370/252; 370/401

(57) ABSTRACT

A monitoring system including a computer system; a data converter connected to the computer system through a cable; one or more panels each connected to the data converter through one or more data lines; the one or more panels obtaining data by measuring a measurable component of a near or remote system. The computer system monitors the one or more panels to determine when an alarm condition exists and to provide data from the one or more panels.

### FIELD

This document generally relates to a monitoring system.

### BRIEF DESCRIPTION OF THE DRAWINGS

FIG. 1 is a simplified diagram of a monitoring system;

FIG. 2 is a simplified block diagram of a computer system;

FIG. 3 is a simplified block diagram of a data converter;

FIG. 4 is a simplified block diagram of a panel;

FIG. 5 is a simplified block diagram of a control module;

FIG. 6 is a simplified block diagram of a monitor module;

FIG. 7 is a flowchart illustrating a method for hardware setup;

FIG. 8 is a flowchart illustrating a method for data converter command;

FIG. 9 is a flowchart illustrating a method for panel operation;

FIG. 10 is a flowchart illustrating a method for initial menu selection;

FIG. 11 is a flowchart illustrating a method for watcher setup;

FIG. 12 is a flowchart illustrating a method for panel setup;

FIG. 13 is a flowchart illustrating a method for panel specification;

FIG. 14 is a flowchart illustrating a method for utilizing panels;

FIG. 15 is a flowchart illustrating a method for presenting module history;

FIG. 16 is a flowchart illustrating a method for recording setup;

FIG. 17 is a flowchart illustrating a method for viewing monitoring shortcuts;

FIG. 18 is a flowchart illustrating a method for viewing alarm listings; and

FIG. 19 is a flowchart illustrating a method for line scanning.

Corresponding reference characters indicate corresponding elements among the several views. The headings used in the figures should not be interpreted to limit the scope of the figures.

### DETAILED DESCRIPTION

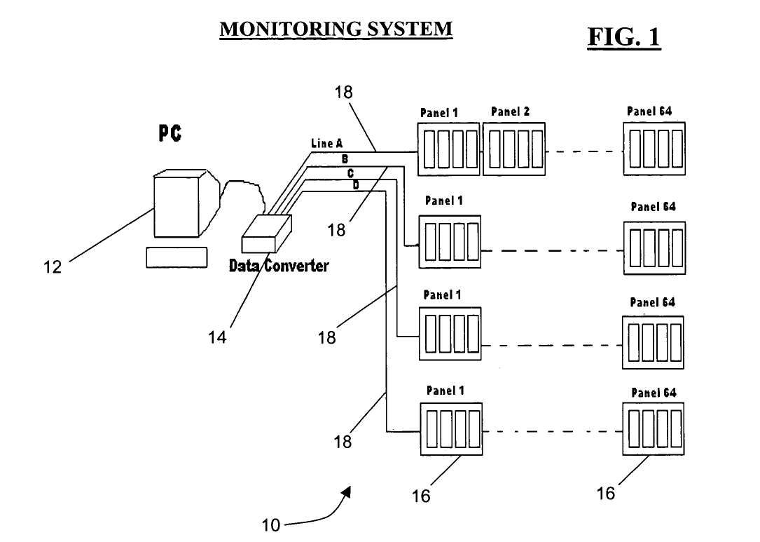

Referring to the drawings, an implementation of a monitoring system is illustrated and generally indicated as 10 in FIG. 1. In this implementation, monitoring system 10 may include two or more panels 16 electrically coupled by one or more data lines 18 to a data converter 14. Data converter 14 may provide monitoring data from one or more data lines 18 to a computer system 12. One implementation of computer system 12 is illustrated in greater detail below.

One or more panels 16 may be devices that monitor status of one or more parameters. In one embodiment, up to sixty-four panels 16 may be operatively connected to a data line 18. One or more panels 16 may use a RS-485 protocol to communicate over one or more data lines 18. In an embodiment, the one or more parameters that are monitored may be measurements from sources including, but not limited to, medical gases, clinical vacuum, WAGD, delivery of gas or vacuum. In another embodiment, the one or more parameters may include pressure level and vacuum level. An implementation of one or more panels 16 is described in greater detail below. However, other implementations of one or more panels 16 are also contemplated.

As noted above, one or more data lines 18 transmit data from one or more panels 16 to data converter 14. In one embodiment, one or more data lines 18 may each connect one or more panels 16 in a series, while in another embodiment one or more data lines 18 may each connect one or more panels 16 in parallel. One or more data lines 18 may be Belden #9841 RS-485 cable or cables with comparable or better shielding, conductivity and capacitance. In addition, one or more data lines 18 may transmit control data from computer system 12 to data converter 14 and one or more panels 16, while monitoring data from one or more panels 16 to computer system 12 through the one or more data lines 18. Other implementations of one or more data lines 18 are also contemplated.

Data converter 14 coordinates the transmission and reception of data between one or more panels 16 and computer system 12. One implementation of data converter 14 and the operation of data converter 14 is described in greater detail below.

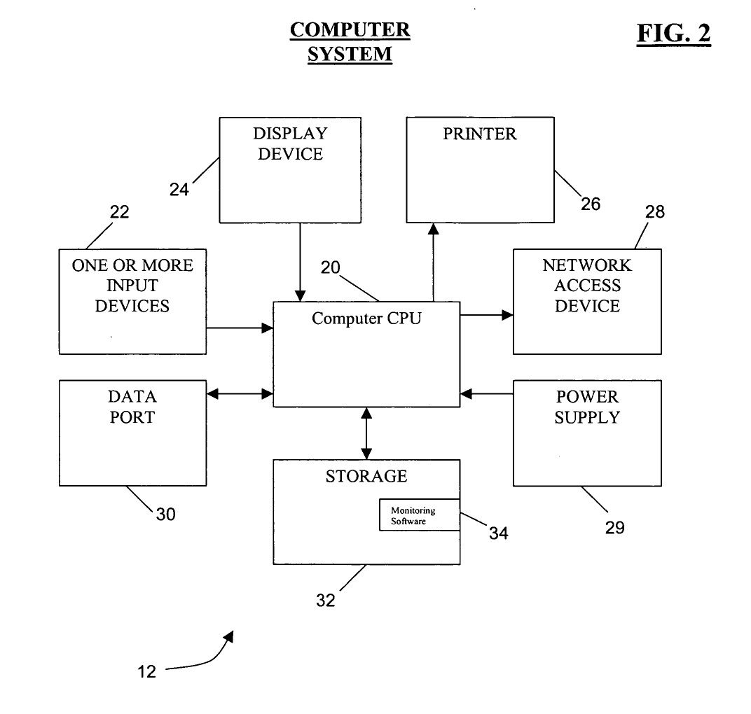

Referring to FIG. 2, an implementation of a computer system 12 is illustrated. In this implementation, computer system 12 may include a central processing unit (CPU) 20, a data port 30 that is electrically connected to CPU 20, one or more input devices 22 that are electrically connected to CPU 20, a power supply 29 electrically connected to CPU 20 to provide power to computer system 12, and a storage 32 that is electrically connected to CPU for providing data storage. In addition, the computer system 12 may include a display device 24 that is electrically connected to CPU 20 for displaying data, a printer 26 that is electrically connected to CPU 20 for printing data, and an optional network access device 28 that is electrically connected to CPU 20 for connecting computer system 12 to a resource (not shown) on a network (not shown). Those skilled in the art will appreciate that computer system 12 may be implemented as a general-purpose computer or a specialized device. Other configurations of computer system 12 are also contemplated.

CPU 20 may direct the operation of the various components of computer system 12. In one embodiment, CPU 20 may be a PENTIUM I 450 MHz or faster housed on a motherboard (not shown), however other CPUs having different speeds and configurations, including multiple CPUs, are also contemplated.

Data port 30 enables computer system 12 to interface with data converter 14 through a connection to send and receive data. In one embodiment, data port 30 may be a RS-232 serial port. However other device interconnects are also contemplated including a Universal Serial Bus (USB) port, a parallel port, a “Firewire” protocol (IEEE 1394) port, and various wireless protocols.

One or more input devices 22 are electrically connected to CPU 20 through a port (now shown) to receive input from a user of computer system 12. The user operates computer system 12 through operation of one or more input devices 22, such as providing commands through a keyboard and/or a mouse. However, alternate peripheral and internal devices beyond a keyboard and a mouse as will be appreciated in the art may be used to obtain direction from a user of computer system 12.

Storage 32 has the capacity to hold and retain data in a digital form for access by CPU 20. In addition, storage 32 may be primary storage and/or secondary storage, and may include memory. In one embodiment, storage 32 may consist of a hard drive having at least 500 megabytes of free hard disk space and at least 128 megabytes of RAM (random access memory), however other configurations with different speeds and capacities are also contemplated.

In one implementation, storage 32 may include monitoring software 34. An implementation of the operation and components of monitoring software 34 is described in greater detail below. In one embodiment, monitoring software 34 may be installed on computer system 12, while in another embodiment monitoring software 34 may be pre-installed on computer system 12.

An operating system (not shown) may also be contained in storage 32 to and control the general operation of computer system 12. The operating system performs various system calls to control computer system 12 on a system level. In one embodiment the operating system may be a MICROSOFT® Windows 2000 program, but other operating systems, such as MICROSOFT® Windows XP, are also contemplated.

As further shown, display device 24 is in operative association with CPU 20 and may be a device capable of visually presenting data to a user of computer system 12. Examples of display devices 24 include personal computer (PC) screens, projection televisions, plasma televisions, liquid crystal displays (LCD), and digital light processing (DLP) displays.

Printer 26 may be included in various implementations of computer system 12 to provide the capability for making a print out or other hard copy of desired data. Examples of printers 26 may include various impact and non-impact printers such as dot matrix printer, daisy wheel printer, chain and brand printer, ink jet printer, thermal transfer printer, bubble jet printer, page printer, LED/LCD printer, dye sublimation printers, digital photo printers, multifunction printer and laser jet printer.

In addition, optional network access device 28 enables computer system 12 to contact outside resources to send and store data. Outside resources may include computer or computer services on an intranet or an extranet, while network access device 28 may include an internal or external network card, a modem, and other wired and wireless accesses devices as will be appreciated in the art.

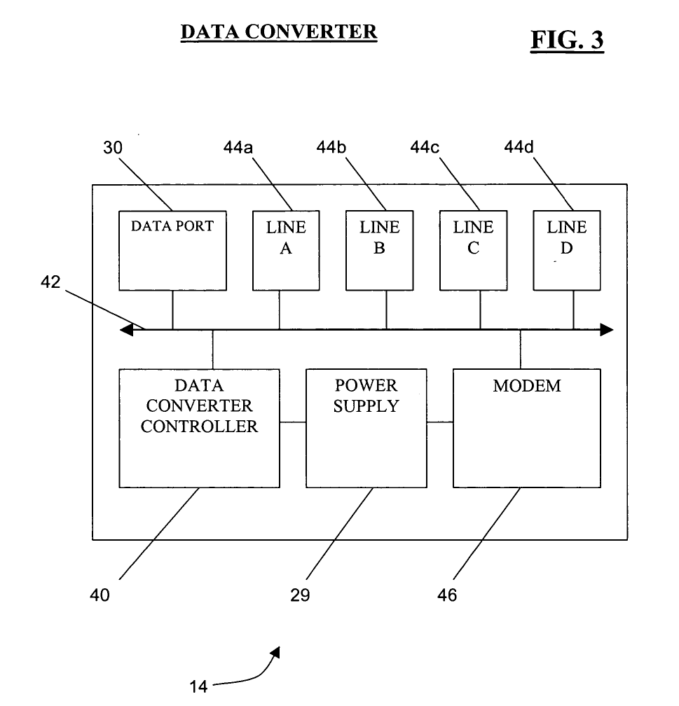

Referring to FIG. 3, an implementation of data converter 14 is illustrated. In this implementation, data converter 14 may include a data converter controller 40, a bus 42 electrically coupled to data converter CPU 40, and a power supply 29 electrically coupled to data converter controller 40 and a modem 46 for providing power to data converter CPU 40. In addition, a data port 30 may be electrically coupled to bus 42 for interfacing with computer system 12, one or more converter connects 44 may be electrically coupled to bus 42, and a modem electronically coupled to bus 42.

Data converter controller 40 may direct the operation of the various components of data converter 14. In one embodiment, data converter controller 40 may be a microcontroller. For example, data converter controller 40 may be a PIC 16F876A microcontroller. However, other controllers having different speeds and configurations including multiple controllers are also contemplated.

Data port 30 enables data converter 14 to interface with computer system 12 through a connection to send and receive data. For example, data port 30 may be a RS-232 serial port, however other device interconnects are also contemplated including a Universal Serial Bus (USB) port, a parallel port, a “Firewire” protocol (IEEE 1394) port, and various wireless protocols. In one embodiment, data port 30 may receive data from computer system 12 in an RS-232 format and then convert the data into TTL (transistor transistor logic) format.

One or more converter connects 44 (shown in FIG. 3 as converter connect 44a, converter connect 44b, converter connect 44c, and converter connect 44d) each receive data from one or more panels 16 through data line 18. In another embodiment, each of the one or more converter connects 44 may be terminal blocks to receive and retain wires from a respective data line 18. In yet another embodiment, each of the one or more converter connects 44 may include an integrated circuit for converting data from RS-485 format into TTL format for transport on bus 42. In one embodiment, each of the one or more converter connects 44 may be toggled between enable and disable for both transmitting and receiving data.

Modem 46 may provide data converter 14 with the capability to send remote data. In one embodiment, modem 46 is a modem that communicates over an analog telephone line, while in another embodiment modem 46 provides communications over a digital telephone line. In another embodiment, modem 46 may receive data in RS 232 format. In one embodiment, the modem may be a 2400 baud modem, however other baud modems are also contemplated. In an embodiment, modem 46 may be a 2400 pbs serial TTL modem module 240 HM-T-W manufactured by Raidcom Research Inc. In yet another embodiment, modem 46 may transmit remote data wirelessly. Finally, modem 46 may be toggled between enable and disable for both transmitting data. Other implementations of modem 46 are also contemplated.

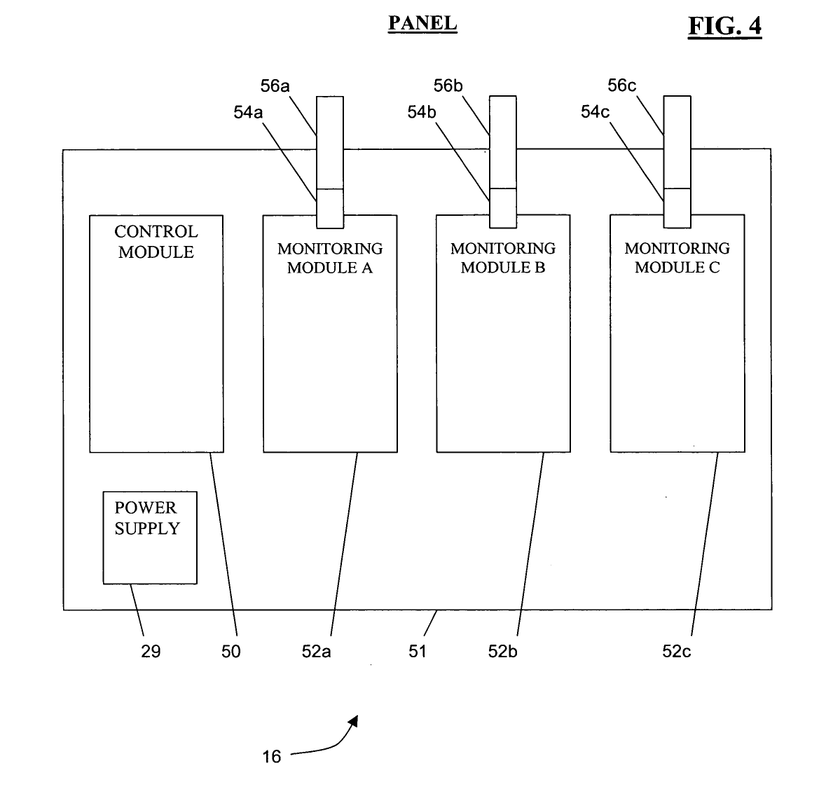

Referring to FIG. 4, an implementation of a configuration of one or more panels 16 is illustrated. In this implementation, a bracket 51 may contain a control module 50 electrically coupled to one or more monitoring modules 52 (shown in FIG. 4 as monitoring module 52a, monitoring module 52b, and monitoring module 52c) and a power supply 29. Implementations of control module 50 and one or more monitoring modules 52 are described in greater detail below.

One or more pigtails 54 (shown in FIG. 4 as pigtail 54a, pigtail 54b, and pigtail 54c) may be used in various embodiments to each connect one of the one or more monitoring modules 52 to a source through a source connection 56 (shown in FIG. 4 as source connection 56a, source connection 56b, and source connection 56c). In one embodiment, the one or more pigtails 54 may enable installation directly to a source through the source connection 56. In one embodiment, one or more pigtails 54 may be made of copper, but other materials are also contemplated. In another embodiment, a remote sensor may be used instead of including one or more pigtails 54.

In an embodiment, power supply 29 may be connected to a 115/230 Volt 50/60 Hertz power source. In one embodiment, power supply may include a 250V 3A fuse, however other fuses or equivalent devices are also contemplated.

Other implementations of one or more panels 16 may include different numbers of monitoring modules 52. Examples of other such implementations may include one monitoring module 52 or six monitoring modules 52.

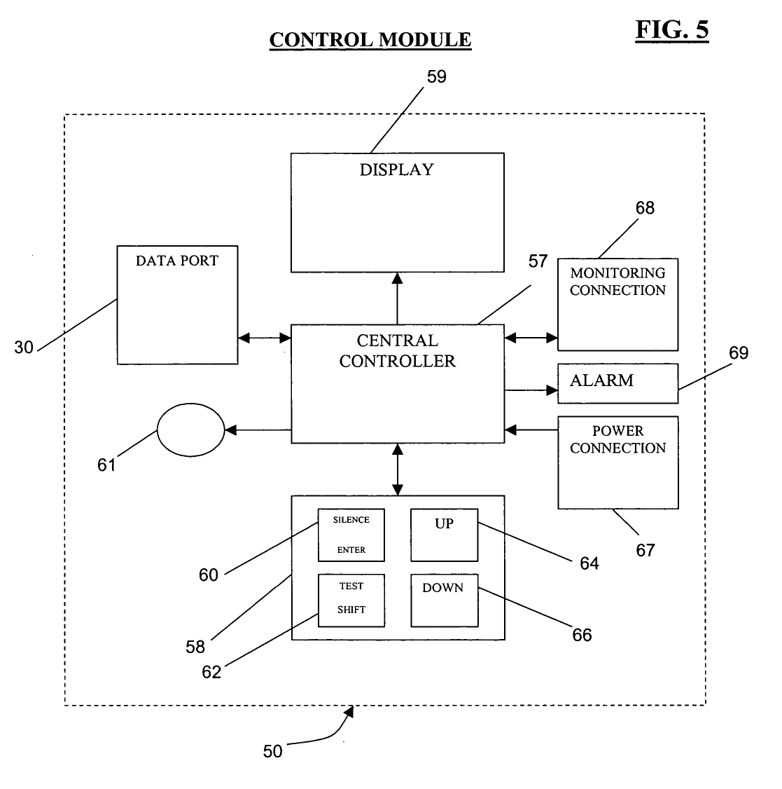

Referring to FIG. 5, an implementation of control module 50 is illustrated. In this implementation, control module 50 may include a central controller 57 electronically coupled to a data port 30, a display 59, a light 61, a control panel 58, and an audio alarm 69. Monitoring connection 68 may be electrically coupled to monitor controller 70 and a power connection 67 for receiving power, such as from power supply 29.

Central controller 57 may direct the operation of the various components of control module 50. In one embodiment, central controller 57 may be a microcontroller, such as a PIC 16F876A microcontroller. However, other controllers having different speeds and configurations, including multiple controllers are also contemplated.

Display 59 may provide a visual readout during operation of control module 50 as described in greater detail below. In one embodiment, display 59 may have one or more seven segment LED displays, however other embodiments of display 59 are also contemplated.

Light 61 may indicate status of control module 50 as described in greater detail below. In one embodiment, light 61 may be an indicator that power has been turned on. In an embodiment, light 61 may be an LED. Light 61 may also illuminate when control module 50 is made operational.

Audio alarm 69 may generate a sound when an alarm condition exists. Implementations using audio alarm 69 are described in greater detail below.

Control panel 58 may include one or more buttons to controlling operation of control module 50. In one embodiment, control panel 58 may include a silence/enter button 60, test/shift button 62, up button 64, and down button 66, however other embodiments are also contemplated. The use of the one or more buttons are described in greater detail below.

In an embodiment, a button (e.g., silence/enter button 60) may turn off one or more alarm outputs 65 when an alarm condition exists on a selected monitor module. In one embodiment, a button (e.g., test/shift button 62) may run a self test of a selected panel 16 and/or be used to increment numbers when control module 50 is in program mode. In another embodiment, one or more buttons (e.g., up button 64 and down button 66) may be used to increment numbers when control module 50 is in program mode and/or to select a different sensor input of one or more sensor inputs 72 (as described below) of a selected monitoring module 52 when multiple sensors are present.

In an implementation, selecting test button 62 may sequentially test each type of one or more monitoring modules 52. In one embodiment, the tests may include a LED display test, a board address display test, a sensor type and set point display test, and an alarm test.

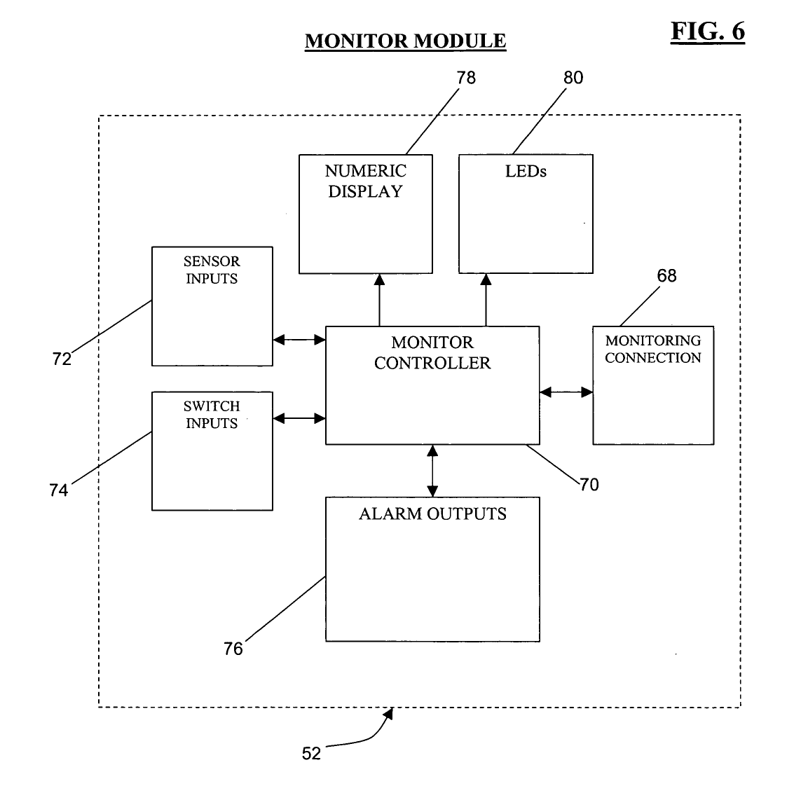

Referring to FIG. 6, an implementation of monitor module 52 is illustrated. In this implementation, a monitor controller 70 is electrically coupled to one or more sensor inputs 72 and one or more switch inputs 74. A numeric display 78 and light emitting diodes (LEDs) 80 may each be electrically coupled to monitor controller 70, while a monitoring connection 68 may be electrically coupled to monitor controller 70. Finally, one or more alarm outputs 76 may be electrically coupled to monitor controller 70.

Monitor controller 70 may direct the operation of the various components of monitor module 52. In one embodiment, monitor controller 70 may be a microcontroller, such as a PIC 16F876A microcontroller. However, other controllers having different speeds and configurations including multiple controllers are also contemplated.

One or more sensor inputs 72 may each connect a sensor that takes readings from one or more devices. In one embodiment, the sensor converts the value of a parameter to an electric signal, and the sensor input 72 passes the signal to monitor controller 70. The monitor controller 70 then converts the electric signal into a value. In another embodiment, one or more sensor inputs 72 may each be used with a sensor to measure or detect a parameter of a device and convert the parameter to an electronic signal. In yet another embodiment, one or more sensor inputs 72 may have an output range of 4-20 milliamps.

One or more switch inputs 74 may receive data from one or more devices. In one embodiment, one or more switch inputs 74 monitor normally closed remote switch signals. In another embodiment, one or more switch inputs 74 may each monitor any device capable of determining whether a circuit is open or closed. In yet another embodiment, one or more switch inputs 74 may each measure reserve in use, liquid level low, high/low pressure, or status of another panel 16.

It should be appreciated that alternate embodiments of monitor module 52 may have either have one or more sensor inputs 72 or one or more switch inputs 74.

In addition, one or more alarm outputs 76 may each provide a signal output on an alarm condition. In one embodiment, the signal output may be a switch, while in another embodiment the signal output may be an audio and/or visual notification of an alarm condition. In one aspect, one or more alarm outputs 76 may be activated when an alarm condition is detected. The one or more alarm outputs 76 may include three switch output including a high alarm output, a low alarm output and a normal alarm output.

Numeric display 78 may provide a visual readout during operation of monitor module 50 as described in greater detail below. In one embodiment, numeric display 78 may be a two position seven segment LED display, however other embodiments are also contemplated.

It should be appreciated that various implementations of monitor module 52 may include various components. Examples of such implementations may include an 8-transducer module, a 10-switch module, a dual display module, a pressure module or a vacuum module.

In one embodiment, monitor module 52 may include a pressure-type module having a two position seven segment LED display as numeric display 78. For example, numeric display 78 may be four green LEDs in a series that each may illuminate to indicate current pressure being in a normal pressure range, a yellow LED at both ends of the four green LEDs that may each illuminate to indicate current pressure is beyond a normal pressure range, and a red LED at both ends of the yellow LEDS that may indicate an alarm condition because of the pressure range. The normal pressure range may be within plus or minus 17% and the pressure range for which an alarm condition may be entered is beyond plus or minus 20%, however other ranges are also contemplated.

In one embodiment, when an alarm condition occurs an LED 80 may be illuminated red and one or more alarm outputs 76 may be activated on monitoring module 52 while audio alarm 69 will sound on control module 50. The illuminated LED may remain red until the alarm condition is cleared, while audio alarm 69 may remain active until silenced or the alarm condition is cleared.

Monitor module 52 may include a vacuum display-type module having a three position seven segment LED display as numeric display 78 that may display continuous vacuum readings as the one or more parameters for a single gas line as the source. In one aspect, a series of green colored LEDs of the one or more LEDs 80 may indicate a normal operating range for the continuous vacuum readings.

In another embodiment where one or more sensor inputs 72 are sensor type C and a vacuum value deviates below a set point, a yellow LED of one or more LEDs 80 may illuminate. When vacuum value deviates below a predetermined alarm point, a red LED of one or more LEDs 80 may illuminate and audio alarm 69 may be activated. The set point and the alarm point may be set prior to distribution or the set point and the alarm point may be defined by a user. For example, the set point may be 14.0 in Hg (47.4 kPa) and the alarm point may be 12.0 in Hg (40.6 kPa).

In yet another embodiment where one or more sensor inputs 72 are sensor type B and a vacuum value deviates below a set point, a yellow LED of one or more LEDs 80 may illuminate. When vacuum value deviates below an alarm point, a red LED of one or more LEDs 80 may illuminate, while audio alarm 69 may sound and one of the one or more alarm outputs 76 may be activated. For example, the set point may be 355 mmHg (47.3 kPa) and the alarm point may be 304 mmHg (40.5 kPa).

In one embodiment, monitor module 52 may monitor more than one parameter, while in one embodiment, monitor module 52 may monitor two parameters. A 10-switch signal module may include ten of the one or more switch inputs 74 and ten corresponding dual color LEDs as the one or more LEDS 80. In addition, one or more switch inputs 74 may have three modes of operation including mode 0 for off, mode 1 for normal and mode 2 for indicator only. For example, mode 0 may indicate that a particular switch input 74 is inactive and a dual color LED is off, while mode 1 may indicate normal operation. During normal operation, dual color LED is illuminated green until a fault condition exists. Upon existence of a fault condition, dual color LED may be illuminated red and audio alarm 69 may sound. Moreover, mode 2 may indicate indicator-only operation. During indicator-only operation, dual color LED may be illuminated green until a fault condition exists. Upon existence of a fault condition, dual color LED may be illuminated yellow.

Monitor module 52 may include an 8-transducer module having eight sensor inputs as one or more sensor inputs 72 and a four position seven segment LED display as numeric display 78 that may display the output of the eight sensor inputs in sequence. For example, eight dual color LEDs may be included as one or more LEDs 80 to continuously indicate the condition of the corresponding sensor. The LED may flash to indicate the sensor input that is being displayed. During normal operation, the eight dual color LEDs may be illuminated green but may illuminate red when a corresponding sensor input detects a fault condition according to one embodiment.

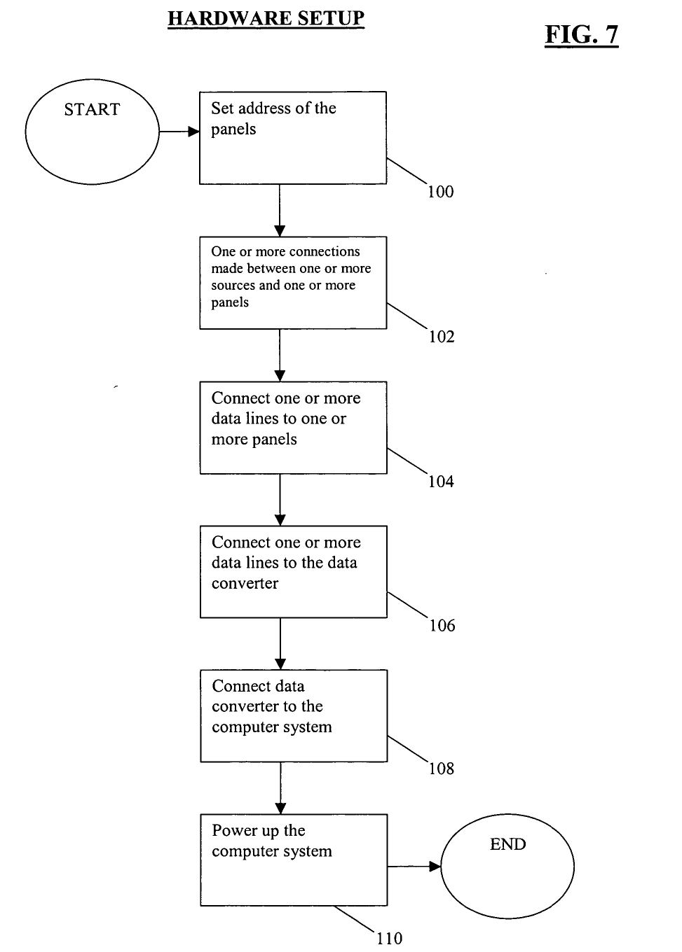

Referring to FIG. 7, an implementation of a method for hardware setup is illustrated. In this implementation, a panel address for each of one or more panels 16 are set at a step 100. In one embodiment, the panel address for each of one or more panels 16 that are to be connected to one of the one or more data lines 18 is provided with a unique integer.

In one embodiment, setting the panel address on one or more panels 16 may be achieved entering a program mode, pressing and holding shift key 62 until display 54 comes on or flashes, selecting an address using up button 64, down button 66 and shift key 62, and pressing enter button 60 to store the address. The panel address may be set on one or more panels 16 prior to distribution.

At step 102, one or more connections may be made between one or more sources and one or more panels 16. For example, the connection may be a gas line between the source and the one or more panels 16. Alternatively, the connection may be a vacuum line between the source and the one or more panels 16. At step 106, one or more data lines 18 may then be connected. In one embodiment, one or more data lines 18 may be run with no splices.

Data converter 14 is connected to computer system 12 at step 108. At step 110, computer system 12 is then powered up. Thereafter, one implementation of the foregoing method is complete. It should be appreciated that in alternate implementations step 100, step 102, step 104, step 106, step 108 and step 110 may occur in different orders.

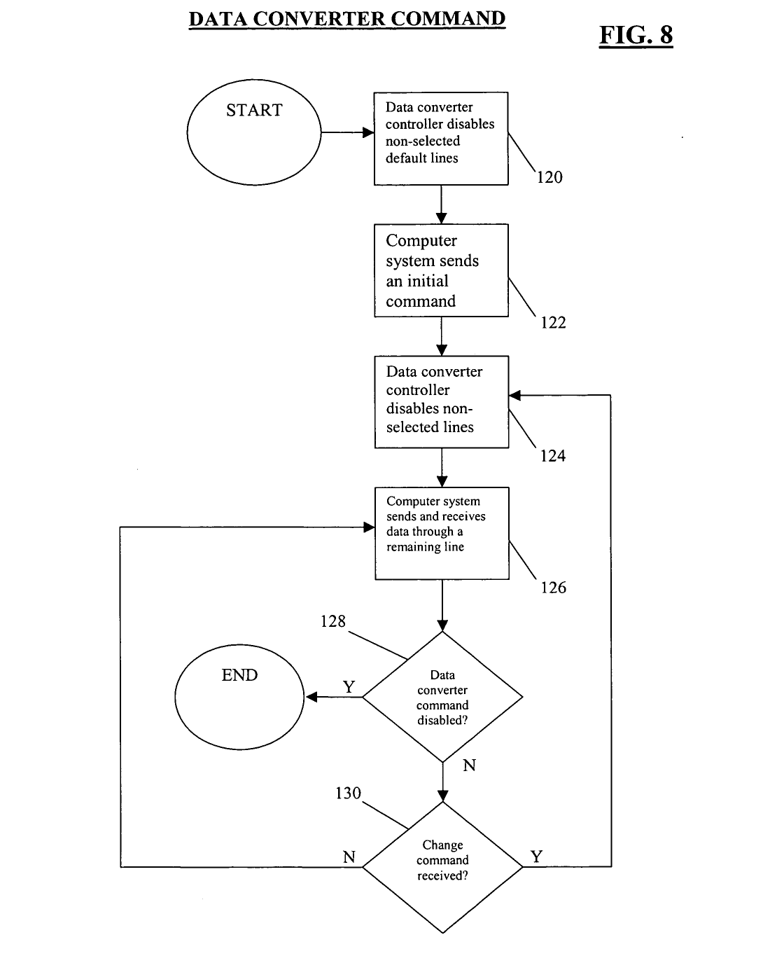

Referring to FIG. 8, an implementation of data converter command is illustrated. In this implementation, data converter controller 40 disables non-selected default lines at step 120. In one embodiment, non-selected default lines may be disabled by toggling off the non-selected converter connects 44. In another embodiment, non-selected default lines may be disabled by toggling on the selected converter connect of the one or more converter connects 44.

At step 122, computer system 12 may send an initial command to data converter 14. Thereafter, data converter controller 40 at step 120 disables non-selected lines at step 120. In one embodiment, non-selected lines may be disabled by toggling off the non-selected converter connects 44. In another embodiment, the non-selected lines may be disabled by toggling on the selected converter connect of the one or more converter connects 44.

Computer system 12 may send and receive data through a remaining line at step 126. At decision point 128, data converter 14 determines whether the command has been disabled. In one embodiment, command may be disabled when power is removed by data converter 14. If command has been disabled at decision point 128, one implementation of the foregoing is complete.

If command has not been disabled at decision point 128, data converter 14 determines whether a change command has been received at decision point 130. If a change command has been received, data converter 14 returns to step 124 to receive a new command and disable non-selected lines. If a change command has not been received, computer system 12 continues to send and receive data through the remaining data line 18 at step 126.

It should be appreciated that other methods of enabling and disabling one or more data lines 18 are also contemplated.

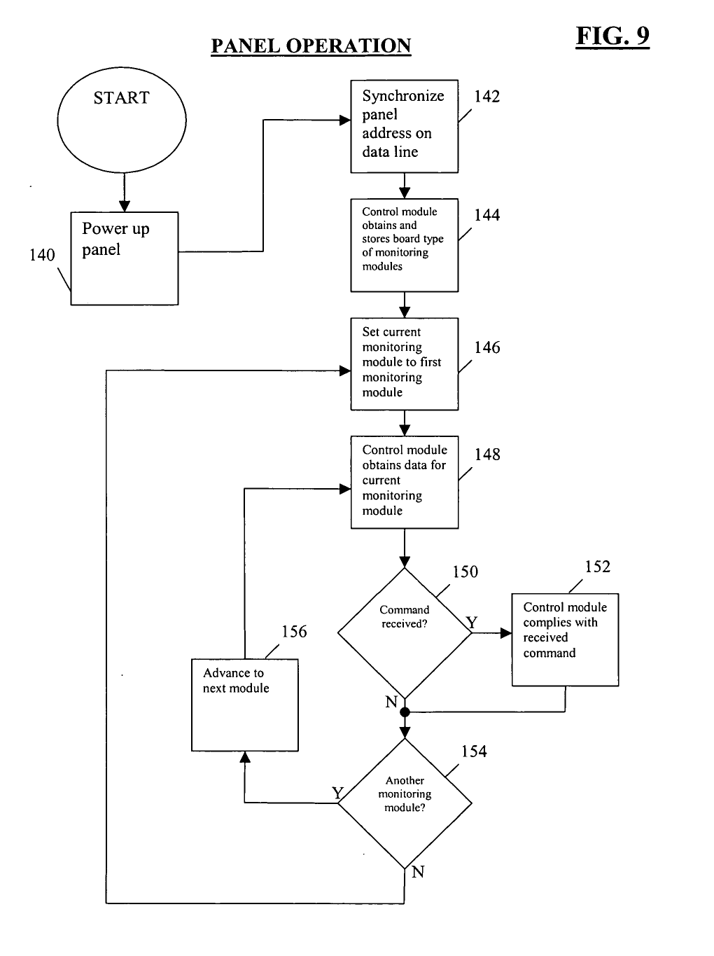

Referring to FIG. 9, an implementation of panel operation is illustrated. In this implementation, a panel 16 of one or more panels 16 is powered up at step 140.

At step 142, panel 16 synchronizes a panel address on one of one or more data lines 18. In one embodiment, the panel address may be set by a user, while in another embodiment the panel address is fixed prior to providing panel 16 to a user. Thereafter, control module 50 of panel 16 obtains and stores a board type of one or more monitoring modules 52 at step 144. The board type may be a pressure/vacuum board type, 10 switch input board type, a dual board type or an 8-transducer board type. Other board types are also contemplated.

At step 146, control module 50 sets a current monitoring module to a first monitoring module 52 of one or more monitoring modules 52. Thereafter, control module 50 at step 148 obtains data for current monitoring module. In one embodiment, the data is stored on the current monitoring module 52 and contains readings from at least one of the zero or more sensor inputs 72 and zero or more switch inputs 74.

Control module 50 at decision point 150 determines whether a command has been received. If a command has been received, control module 50 complies with the received command at step 152. If no command is received, control module 50 proceeds to decision point 154. In one embodiment, the command may be a request to provide data to computer system 12.

At decision point 154, control module 50 determines whether there is another monitoring module 52. If there is another monitoring module 52, control module 50 advances to the next monitoring module 52 at step 156 and returns to step 148. If there is not another monitoring module 52, control module 50 returns to step 146 in order to return to first monitoring module 52.

It should be appreciated that in one embodiment of the foregoing method panel 16 may continue to operate until the power is disabled from panel 16 or panel 16 is powered down.

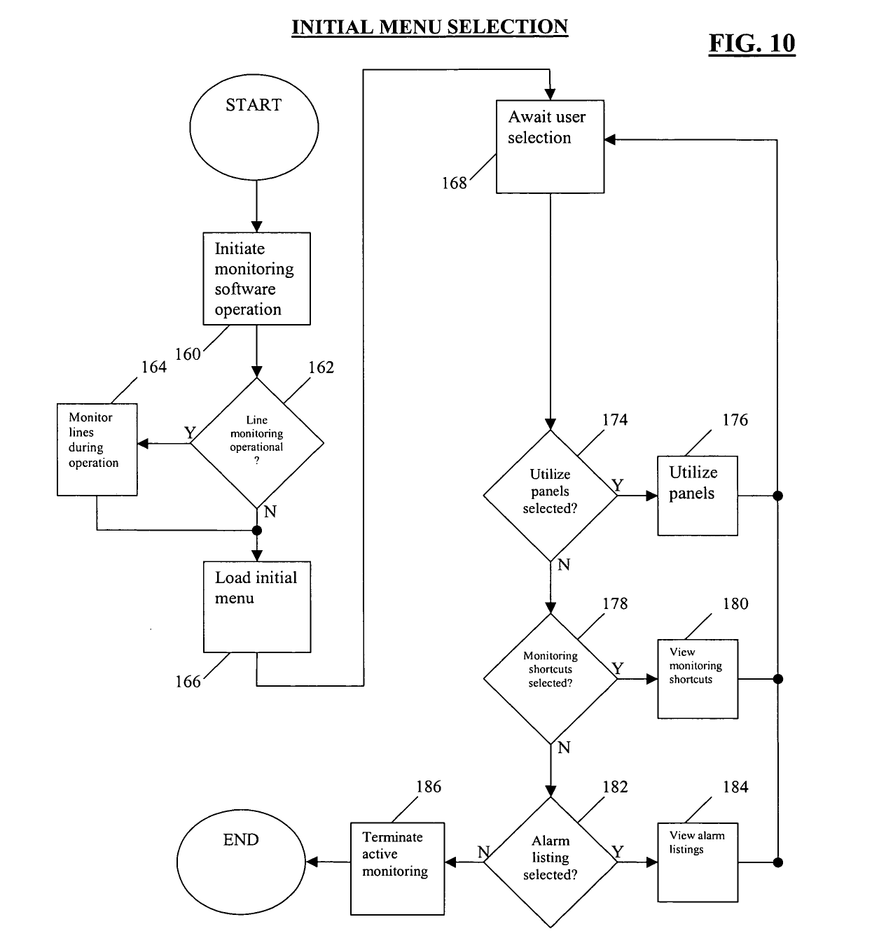

Referring to FIG. 10, an implementation of initial menu selection is illustrated. In this implementation, monitoring software 34 is initiated at step 160. Thereafter, monitoring software 34 at decision point 162 determines whether line monitoring is operational. If line monitoring is operational, then monitoring software 34 at step 164 begins monitoring lines during operation of monitoring software 34 and proceeds to step 166. If line monitoring is not operational, monitoring software 34 proceeds directly to step 166. One implementation of line monitoring by line scanning is described in greater detail below.

Monitoring software 34 at step 166 loads an initial menu. Thereafter, monitoring software 34 awaits a selection from the user of a desired action. At decision point 174, monitoring software 34 determines whether utilize panels was selected. If selected, one or more panels 16 are utilized at step 176. One implementation of utilizing one or more panels 16 is described in greater detail below. If utilize panels was not selected, monitoring software 34 proceeds to decision point 178.

At decision point 178, monitoring software 34 determines whether a monitoring shortcut was selected. If selected, monitoring software 34 proceeds to a monitoring shortcut at step 180. Several implementations of monitoring shortcuts are described in greater detail below. If a monitoring shortcut was not selected, monitoring software 34 proceeds to decision point 182.

Monitoring software 34 at decision point 182 determines whether alarm listing was selected. If selected, the alarm listings are shown at step 176. One implementation of showing the alarm listings is described in greater detail below. If alarm listing was not selected, monitoring software 34 proceeds to step 186. At step 186, monitoring software 34 terminates the active monitoring of one or more data lines 18. Thereafter, an implementation of the foregoing method is complete.

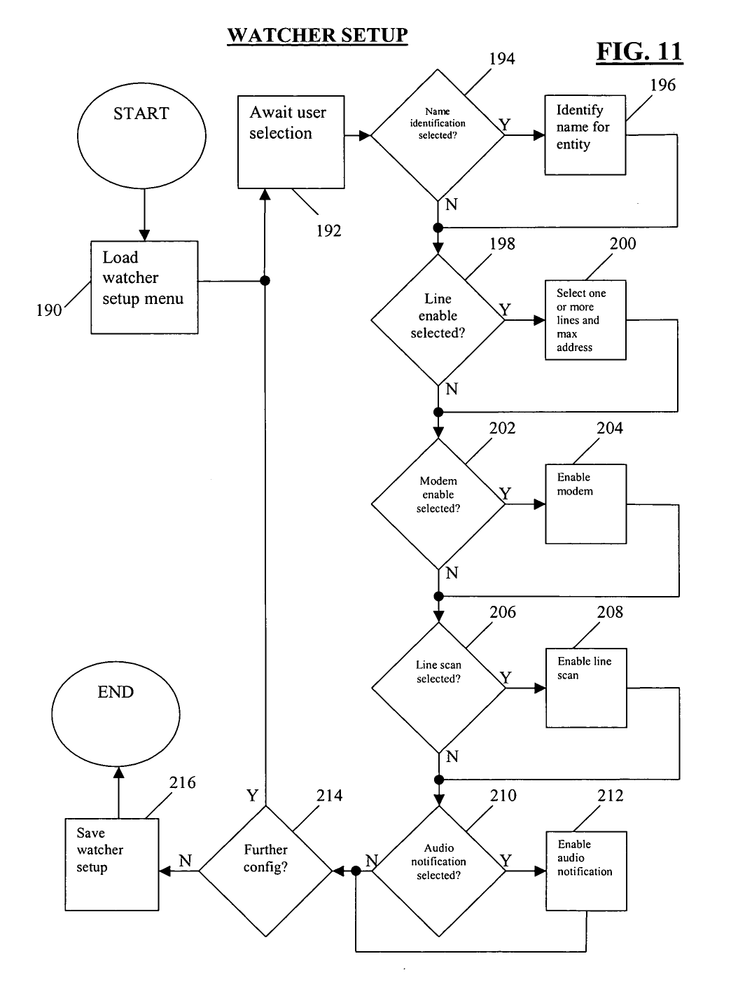

Referring to FIG. 11, an implementation of watcher setup is illustrated. In this implementation, monitoring software 34 at step 190 loads watcher setup menu. Thereafter, monitoring software 34 awaits user selection at step 192.

Monitoring software 34 at decision point 194 determines whether a name identification was selected. If selected, a name is identified at step 196. If name identification was not selected at decision point 194 or after step 196, monitoring software 34 proceeds to decision point 198.

At decision point 198, monitoring software 34 determines whether line enabled was selected. If selected, one or more data lines 18 are selected for monitoring at step 200. In one embodiment, a maximum address may also be identified for one or more data lines 18. If one or more data lines 18 are not selected at decision point 198 or after step 200, monitoring software 34 proceeds to decision point 202.

Monitoring software 34 at decision point 202 determines whether modem enable was selected. If selected, modem 46 is enabled at step 202. In one embodiment, a telephone number may be further identified to provide notification of alarms. If enable modem 46 was not selected at decision point 202 or after step 204, monitoring software 34 proceeds to decision point 206.

At decision point 206, monitoring software 34 determines whether enabling line scan was selected. If selected, line scanning is enabled at step 208. An implementation for enabling line scanning is described in greater detail below. If enabling line scan is not selected at decision point 206 or after step 208, monitoring software 34 proceeds to decision point 210.

Monitoring software 34 at decision point 210 determines whether audio notification was selected. If selected, audio notification is enabled at step 212. If audio notification was not selected at decision point 210 or after step 212, monitoring software 34 proceeds to decision point 214.

At decision point 214, monitoring software 34 determines whether further configuration is desired. If further configuration is desired, monitoring software 34 returns to step 192 to await user selection. If no further configuration is desired, monitoring software 34 saves watcher setup at step 216. Thereafter, an implementation of the foregoing is complete.

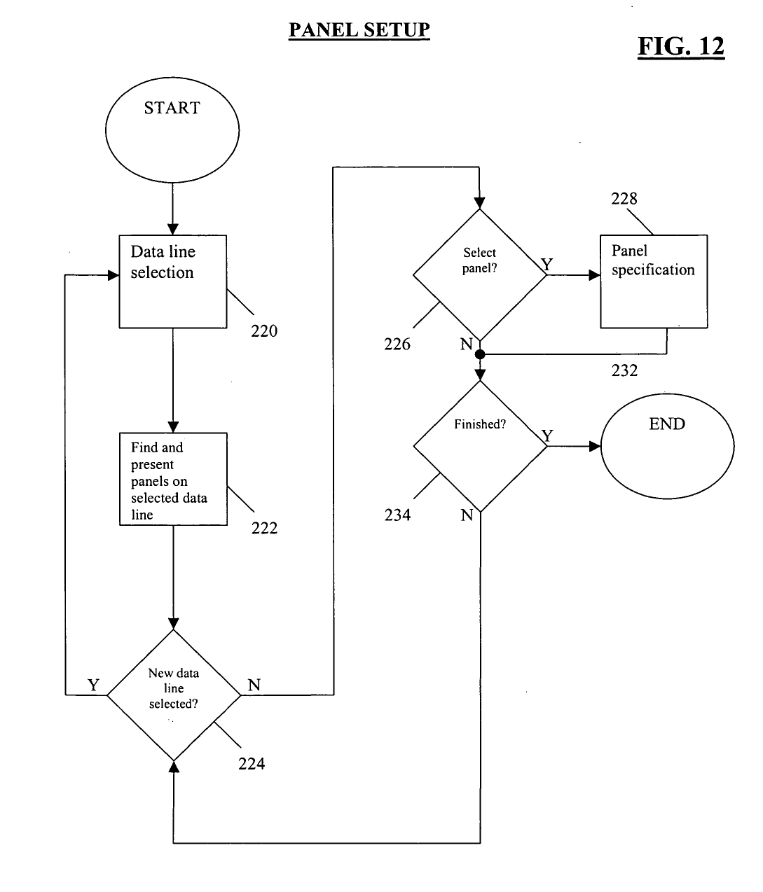

Referring to FIG. 12, an implementation of panel setup is illustrated. In this implementation, one of the one or more data lines 18 is selected at step 220. Thereafter, monitoring software 34 at step 222 finds and presents one or more panels 16 on the selected data line 18.

At decision point 224, monitoring software 34 determines whether a new data line 18 has been selected. If a new data line 18 has been selected, monitoring software 34 returns to step 222 to find and present one or more panels 16 on the newly selected data line 18. If a new data line 18 has not been selected, monitoring software 34 proceeds to decision point 226.

Monitoring software 34 at decision point 226 determines whether one of the one or more panels 16 have been selected. If selected, the selected panel 16 is specified at step 228. An implementation of panel specification is described in greater detail below. If one of the one or more panels 16 was not selected at decision point 226 or after step 228, monitoring software 34 proceeds to decision point 234.

Monitoring software 34 at decision point 234 determines whether panel setup is finished. If panel setup is not finished, alarm software returns to decision point 224. If panel setup is finished, an implementation of the foregoing method is complete.

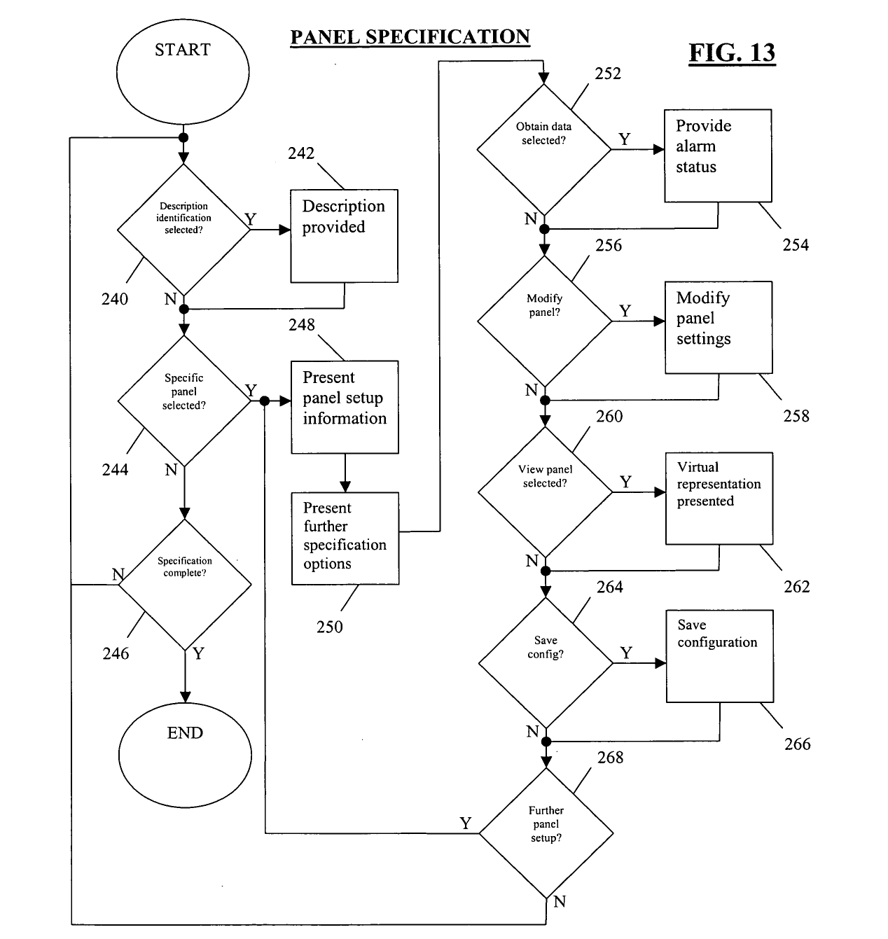

Referring to FIG. 13, an implementation of panel specification is illustrated. In this implementation, monitoring software 34 at decision point 240 determines whether description identification was selected. If description identification was selected, a description is provided at step 242. In one embodiment, the description may be a name for a panel 16 indicating location and/or identification of panel 16. If description identification was not selected at decision point 240 or after step 242, monitoring software 34 proceeds to decision point 244.

At decision point 244, monitoring software 34 determines whether one of the one or more panels 16 has been selected. If a panel 16 has been selected, monitoring software 34 at step 248 presents panel setup information. Thereafter, monitoring software 34 presents further setup options at step 250.

After step 250, monitoring software 34 at decision point 252 determines whether obtain data has been selected. If obtain data has been selected, monitoring software 34 at step 254 provides the alarm status of selected panel 16. If obtain data was not selected at decision point 252 or after step 254, monitoring software 34 proceeds to decision point 256.

Monitoring software 34 at decision point 256 determines whether modify panel has been selected. If modify panel has been selected, monitoring software 34 at step 258 enables modification of the settings of selected panel 16. If modify panel was not selected at decision point 256 or after step 258, monitoring software 34 proceeds to decision point 260.

At decision point 260, monitoring software 34 determines whether view panel has been selected. If view panel has been selected, monitoring software 34 provides a virtual representation of selected panel 16 at step 262. If view panel was not selected at decision point 260 or after step 262, monitoring software 34 proceeds to decision point 264.

At decision point 264, monitoring software 34 determines whether saving the configuration has been selected. If selected, the configuration is saved at step 266. In one embodiment the configuration is saved in a file on storage 32, however other embodiments are also contemplated. If saving the configuration was not selected at decision point 264 or after step 266, monitoring software 34 proceeds to decision point 268.

Monitoring software 34 at decision point 268 determines whether further panel setup is desired. If no further panel setup is desired, monitoring software 34 returns to decision point 240. If further panel setup is desired, alarm system returns to step 248.

If no panel setup was selected at step 244, monitoring software 34 at decision point 246 determines whether the panel setup is complete. If the setup is not complete, monitoring software 34 returns to decision point 240. If the panel setup is complete, an implementation of the foregoing method is complete.

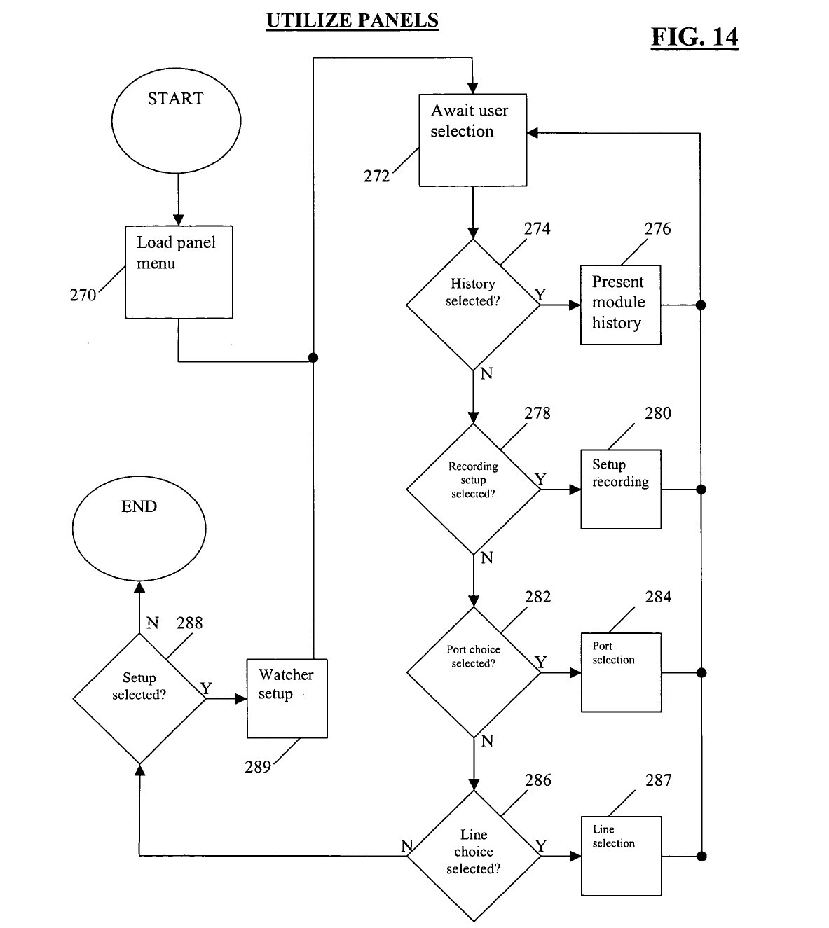

Referring to FIG. 14, an implementation of utilizing panels is illustrated. In this implementation, monitoring software 34 loads a panel menu at step 270. Thereafter, monitoring software 34 at step 272 awaits a user selection of desired action.

Monitoring software 34 at decision point 274 determines whether history has been selected. If history has been selected, monitoring software 34 at step 276 presents the module history and returns to step 272. If history has not been selected, monitoring software 34 proceeds to decision point 278.

At decision point 278, monitoring software 34 determines whether recording setup has been selected. If recording setup was selected, monitoring software 34 at step 280 enables user to set up recording of one or more panels 16 and returns to step 272. An implementation of setting up recording of one or more panels is described in greater detail below. If recording setup has not been selected, monitoring software 34 proceeds to decision point 282.

Monitoring software 34 at decision point 282 determines whether a port choice has been selected. If a port choice has been selected, monitoring software 34 at step 284 selects one of the one or more converter connects 44 and returns to step 272. If a port choice has not been selected, monitoring software 34 proceeds to decision point 286.

At decision point 286, monitoring software 34 determines whether line choice was selected. If line choice was selected, monitoring software 34 at step 287 selects one of the one or more data lines 18 and returns to step 272. If line choice was not selected, monitoring software 34 proceeds to decision point 288.

At decision point 288, monitoring software 34 determines whether setup was selected. If setup was selected, monitoring software 34 has watcher setup at step 289 and returns to step 272. One implementation of watcher setup is described in greater detail below. If setup was not selected, an implementation of the foregoing method is complete.

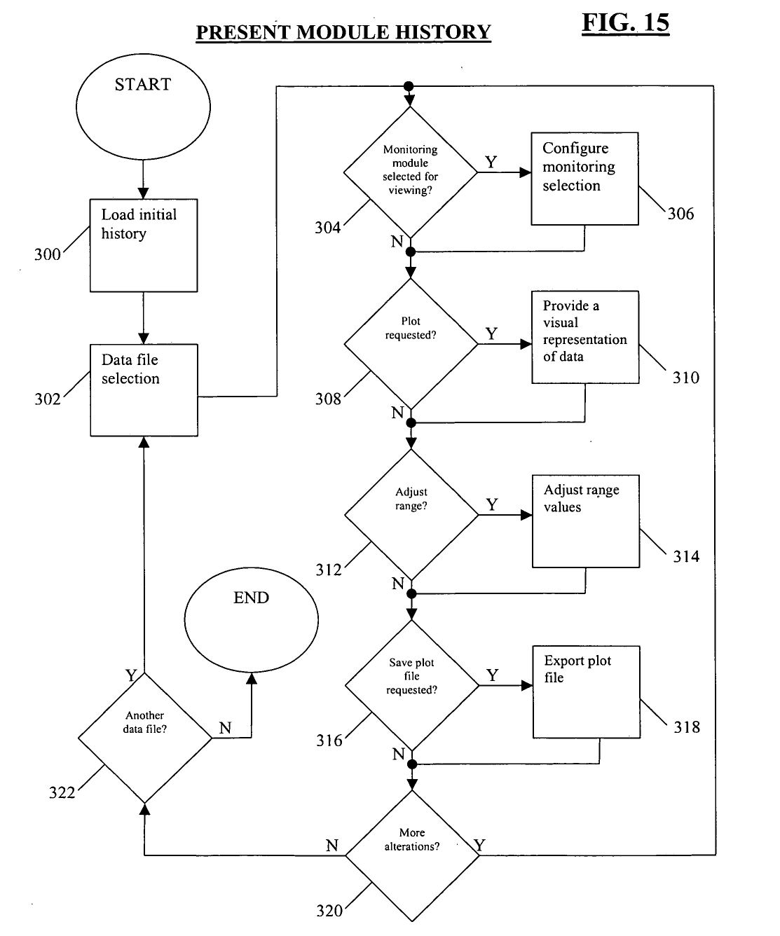

Referring to FIG. 15, an implementation of presenting module history is illustrated. In this implementation, monitoring software 34 launches initial history at step 300. Thereafter, monitoring software 34 selects a data file at step 302.

At decision point 304, monitoring software 34 determines whether one of the one or more monitoring panels 52 have been selected for viewing. If one of the one or more monitoring panels 52 have been selected, monitoring software 34 at step 306 configures the monitoring selection. If none of the one or more monitoring panels 52 have been selected at decision point 304 or after step 306, monitoring software 34 proceeds to decision point 308.

Monitoring software 34 at decision point 308 determines whether a plot has been requested. If a plot has been requested, monitoring software 34 at step 310 provides a visual representation of the selected data. If a plot has not been requested at decision point 308 or after step 310, monitoring software 34 proceeds to decision point 312.

At decision point 312, monitoring software 34 determines whether to adjust range values. If the range values are to be adjusted, monitoring software 34 at step 314 adjusts the range values. If the range values are not to be adjusted at decision point 312 or after step 314, monitoring software 34 proceeds to decision point 316.

Monitoring software 34 at decision point 316 determines whether a plot file save has been requested. If requested, monitoring software 34 at step 318 exports the plot data into a plot file. If not requested at decision point 316 or after step 318, monitoring software 34 proceeds to decision point 320.

At decision point 320, monitoring software 34 determines whether more alterations are to be made to the plot. If further alterations are to be made, monitoring software 34 returns to decision point 304 for further processing. If no further alterations are to be made, alarm software proceeds to decision point 322.

Monitoring software 34 at decision point 322 determines whether another data file was selected. If another data file was selected, monitoring software 34 returns to step 302. If another data file was not selected, an implementation of the foregoing method is complete.

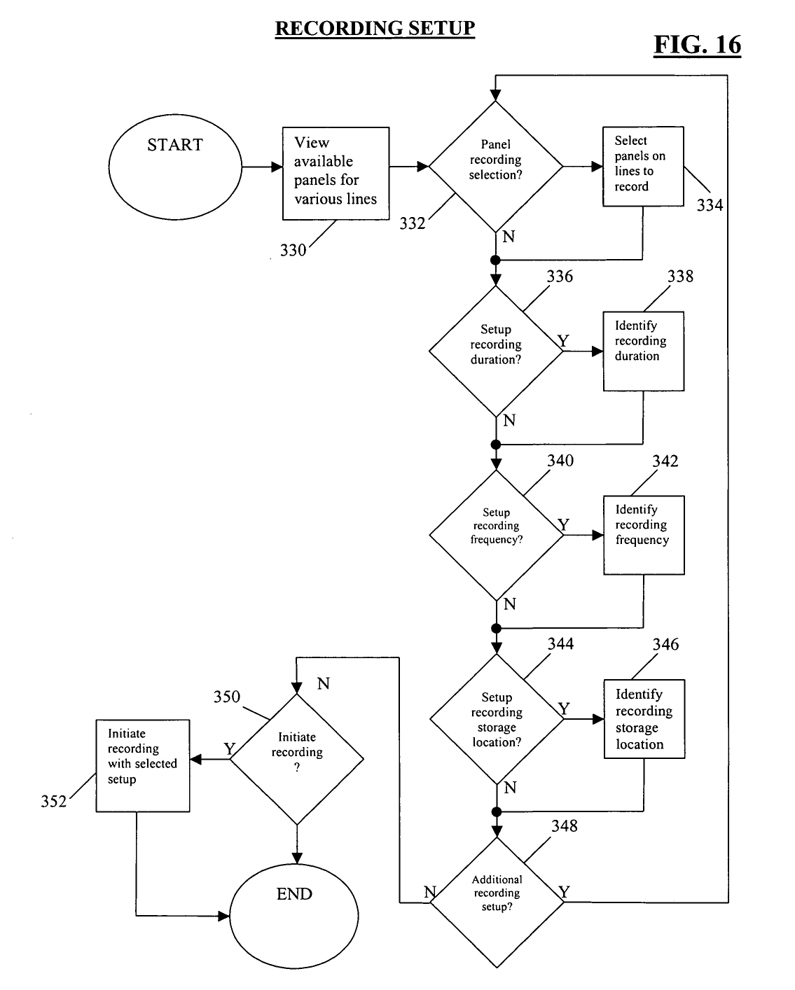

Referring to FIG. 16, an implementation of recording setup is illustrated. In this implementation, monitoring software 34 views the one or more panels 16 from the one or more data lines 18 at step 330.

Monitoring software 34 at decision point 332 determines whether panel recording has been selected. If panel recording has been selected, monitoring software 34 at step 334 selects one or more panels 16 on one or more data lines 18 to record. If panel recording has not been selected at decision point 332 or after step 334, monitoring software 34 proceeds to decision point 336.

At decision point 336, monitoring software 34 determines whether to setup recording duration. If setup recording duration was selected, monitoring software 34 at step 338 identifies a recording duration. If setup recording duration was not selected at decision point 336 or after step 338, monitoring software 34 proceeds to decision point 340.

Monitoring software 34 at decision point 340 determines whether to setup recording frequency. If setup recording frequency has been selected, monitoring software 34 at step 342 identifies a recording frequency. If setup recording frequency has not been selected at decision point 340 or after step 342, monitoring software 34 proceeds to decision point 344.

At decision point 344, monitoring software 34 determines whether to setup a recording storage location. If setup recording storage location has been selected, monitoring software 34 at step 346 identifies a recording storage location. If setup recording storage location has not been selected at decision point 344 or after step 346, monitoring software 34 proceeds to decision point 348.

Monitoring software 34 at decision point 348 determines whether there is additional recording setup. If there is additional recording setup, monitoring software 34 returns to decision point 332. If there is no additional recording setup, monitoring software 34 proceeds to decision point 350.

At decision point 350, monitoring software 34 determines whether to initiate recording. If recording has been initiated, monitoring software 34 at step 352 initiates recording setup with the selected setup. If recording has not been initiated at decision point 350 or after step 352, an implementation of the foregoing method is complete.

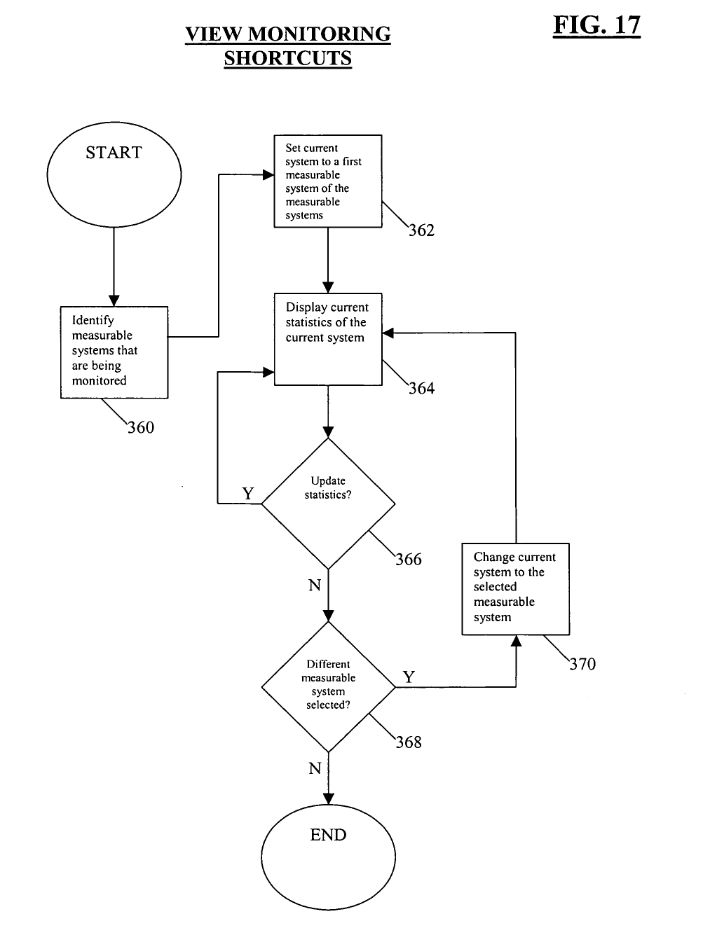

Referring to FIG. 17, an implementation of viewing monitoring shortcuts is illustrated. In this implementation, monitoring software 34 identifies the one or more systems that are being monitoring by monitoring system 10 at step 360 (e.g., measurable systems). In one embodiment, the one or more systems may include compressor and dryer systems, vacuum systems, a bulk system and manifolds, but other embodiments may include different systems as will be appreciated in the art.

Monitoring software 34 at step 362 sets a current system to a first measurable system of the one or more measurable systems. In one embodiment, the first measurable system is a default measurable system.

At step 364, monitoring software 34 displays current statistics of the current system. In one embodiment, the current statistics may include pump on/off, pump in alarm mode, pressure in source, regular tank/reserve tank/emergency reserve tank, bank/low bank, and pressure in bank.

Monitoring software 34 determines at decision point 366 whether to update the current statistics. In one embodiment the update is at the request of a user, while in another embodiment monitoring software 34 automatically updates the current statistics after a period of time. If an update is to be provided, monitoring software 34 returns to step 364. If no update is to be provided, monitoring software 34 proceeds to decision point 368.

At decision point 368, monitoring software 34 determines whether a different measurable system has been selected. If a different measurable system has been selected, monitoring software 34 at step 370 changes the current system to the selected measurable system and returns to step 364. If a different measurable system has not been selected, an implementation of the foregoing method is complete.

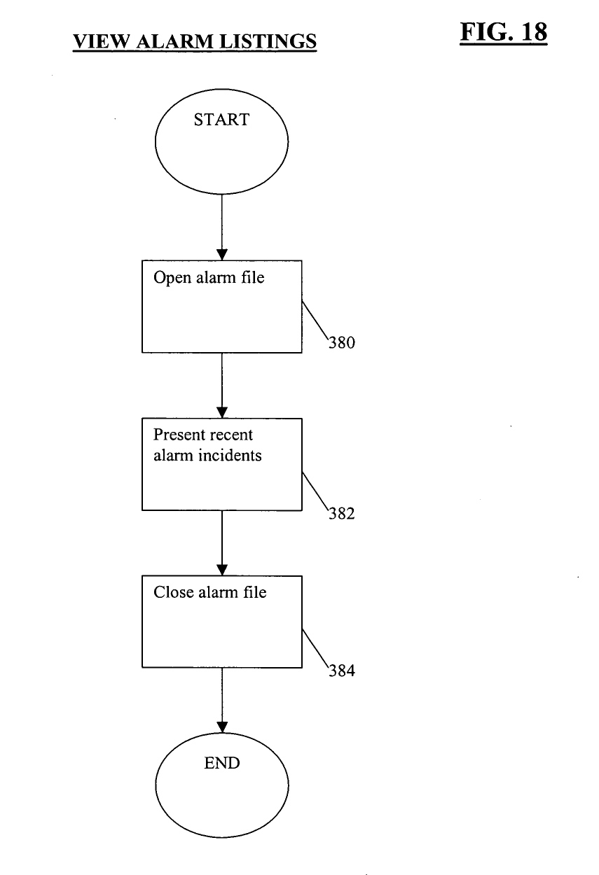

Referring to FIG. 18, an implementation of viewing alarm listings is illustrated. In this implementation, monitoring software 34 opens an alarm file at step 380.

Monitoring software 34 at step 382 presents recent alarm incidents at step 382. In one embodiment, recent alarm incidents may be the last thirty two alarm incidents, but other configurations including differing the number of alarm incidents is also contemplated.

At step 384, monitoring software 34 closes the alarm file. Thereafter, an implementation of the foregoing is complete.

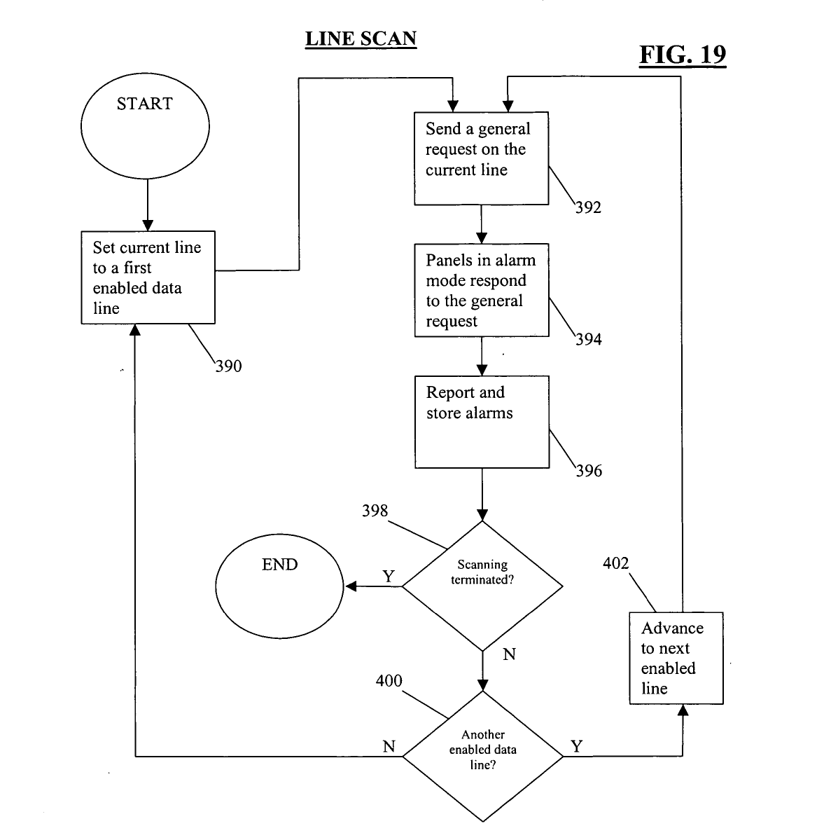

Referring to FIG. 19, an implementation of line scan is illustrated. In this implementation, monitoring software 34 sets a current line to a first enabled data line. In one embodiment, the first enabled data line may be selected during line scan setup, while in another embodiment the first enabled data line may be set as a default.

Monitoring software 34 sends a general request on the current line at step 392. In one embodiment, one or more panels 16 are each set to respond to their specific address and an out-of-range address and the general request references an out-of-range address. For example, the out-of-range address may be zero.

At step 394, any of the one or more panels 16 that are in alarm mode respond to the general request. In one embodiment, the one or more panels 16 that are in alarm mode respond at a time that is a fraction of a second times the address number of the one or more panels 16 compared to the total number of panels 16 or the maximum number of panels 16 for a particular data line 18.

Monitoring software 34 at step 396 reports the alarms and/or stores the alarms in an alarm file. In one embodiment, the alarms are stored in the alarm file in a comma delimited format, however other embodiments are also contemplated. The alarm file may be rewritten every time a new alarm condition occurs or is satisfied, however other embodiments are also contemplated.

At decision point 398, monitoring software 34 determines whether to terminate scanning. If scanning is not terminated, monitoring software 34 proceeds to decision point 400. If scanning is terminated at decision point 398, an implementation of the foregoing method is complete.

Monitoring software 34 at decision point 400 determines whether there is another enabled data line 18. If there is another enabled data line 18, monitoring software 34 advances to the next enabled data line 18 and returns to step 392. In one embodiment, advancing to the next enabled data line 18 is enabling and disabling integrated circuits in connect blocks. If there is not another enabled data line 18, monitoring software 34 returns to step 390.

It should be understood from the foregoing that, while particular implementations have been illustrated and described, various modifications can be made thereto and are contemplated herein. It is also not intended that the invention be limited by the specific examples provided within the specification.

What is claimed is:

1. A monitoring system, the system comprising:
a computer system;
a data converter connected to the computer system through a cable; and
one or more panels each connected to the data converter through one or more data lines, the one or more panels obtaining data by measuring a measurable component of a system;
whereby the computer system monitors the one or more panels to determine when an alarm condition exists and provide data from the one or more panels.

2. The monitoring system of claim 1, wherein the one or more panels comprises a control module electronically coupled to one or more monitoring modules.

3. The monitoring system of claim 2, wherein the control monitor includes a central controller.

4. The monitoring system of claim 3, wherein the central controller is a microcontroller.

5. The monitoring system of claim 1, wherein the one or more panels comprises a control module electronically coupled to one or more monitoring modules.

6. The monitoring system of claim 5, wherein the monitoring modules are selected from the group consisting of an 8-transducer module, a 10-switch module, a dual display module, a pressure module or a vacuum module.

7. The monitoring system of claim 6, wherein the pressure module has a LED display to indicate an alarm condition.

8. The monitoring system of claim 6, wherein the 10-switch module has three modes of operation.

9. The monitoring system of claim 6, wherein the 8-transducer module has a four position LED display.

10. The monitoring system of claim 1, wherein the system contains from one to sixty-four panels.

11. The monitoring system of claim 10 wherein the parameters being monitored are selected from the group consisting of medical gases, clinical vacuum, WAGD, delivery of gas or vacuum.

12. The monitoring system of claim 1, wherein the data converter is provided with a modem to send remote data.

13. A monitoring system, the system comprising:
a computer system;
a data converter connected to the computer system through a cable; and
one or more panels each connected to the data converter through one or more data lines, the one or more panels obtaining data by measuring a measurable component of a system;
whereby the computer system monitors the one or more panels to determine when an alarm condition exists and provide data from the one or more panels; wherein the one or more panels comprises a control module electronically coupled to one or more monitoring modules; wherein the monitoring modules are selected from the group consisting of an 8-transducer module, a 10-switch module, a dual display module, a pressure module and a vacuum module.
